(19) United States
(12) Patent Application Publication
(10) Pub. No.: US 2014/0204043 A1
(43) Pub. Date: Jul. 24, 2014

(54) TOUCH PANEL

(71) Applicants: Yi-Chun Lin, Changhua County (TW); Ming-Kung Wu, Taichung City (TW); Chin-Pei Hwang, Taichung City (TW); Kuo-Hsing Chen, New Taipei City (TW); Yu-Ting Chen, Taoyuan County (TW); Chen-Hao Su, Taichung City (TW); Yun-Bin Lee, Taichung City (TW); Kuo-Chang Su, Taichung City (TW); Yan-Ling Li, Taichung City (TW)

(72) Inventors: Yi-Chun Lin, Changhua County (TW); Ming-Kung Wu, Taichung City (TW); Chin-Pei Hwang, Taichung City (TW); Kuo-Hsing Chen, New Taipei City (TW); Yu-Ting Chen, Taoyuan County (TW); Chen-Hao Su, Taichung City (TW); Yun-Bin Lee, Taichung City (TW); Kuo-Chang Su, Taichung City (TW); Yan-Ling Li, Taichung City (TW)

(73) Assignee: WINTEK CORPORATION, Taichung City (TW)

(21) Appl. No.: 14/157,524

(22) Filed: Jan. 17, 2014

(30) Foreign Application Priority Data
Jan. 18, 2013 (TW) 102102028

(51) Int. Cl. G06F 3/044

(52) U.S. Cl. CPC G06F 3/044
USPC 345/173

(57) ABSTRACT

A touch panel including a substrate, a decoration layer, and conductive elements is provided. The decoration layer has an outer margin adjacent to an edge of the substrate and an inner margin opposite to the outer region. A reference line is away from the inner margin with a distance of at least 20 μm towards a direction away from the outer margin. At least one of the conductive elements includes a cross-interface portion which covers the decoration layer and a region of the substrate without the decoration layer. A first distance and a second distance between two adjacent cross-interface portions are provided in a region outward of the reference line to the outer margin of the decoration layer, and in a region inward of the reference line, respectively. The first distance is greater than the second distance. The conductive elements construct touch sensing units for forming a capacitance coupling.

### CROSS-REFERENCE TO RELATED APPLICATION

This application claims the priority benefit of Taiwan application serial no. 102102028, filed on Jan. 18, 2013. The entirety of the above-mentioned patent application is hereby incorporated by reference herein and made a part of this specification.

### BACKGROUND

1. Field of the Application

The invention relates to a touch panel, and more particularly, to a touch panel disposed with a light resistant layer.

2. Description of Related Art

Input interfaces for many information products have been transformed from the traditional devices, such as keyboard or mouse, to touch devices. Therefore, the touch panel has been subjected to a wide range of applications. Generally, in order to transmit signals generated by an operation of a user using the touch panel, a plurality of wires are usually required and preferably disposed at a peripheral region of the touch panel. In order to avoid the wires be exposed on the outside of the touch panel thereby improving an overall appearance of device, a decoration layer is commonly disposed around the touch panel for concealing these wires.

The decoration layer constructed for concealing these wires merely covers a portion of the surface of a substrate of the touch panel, so that the decoration layer is a bulge structure. Although using the decoration layer in a conventional process may conceal the wires, an adverse influence on a production of touch sensor electrodes is caused by the bulge structure of the decoration layer, or the material characteristics of the decoration layer. For example, in general, lithography and etching are used to pattern a conductive material for constructing the touch sensor electrodes; however, the amount of exposure on a photoresist pattern having a bulge structure may be unable to be well controlled. Moreover, when the conductive material is deposited continuously on the bulge structure and the substrate, an elevation difference and a slope between the bulge structure and the substrate may also affect a crystalline density of the conductive material to become uneven, and thereby problems, such as an over etching phenomenon and even an etching disconnection, may prone to occur near a junction of the bulge structure and the substrate. As shown in FIG. 12, it shows an undesired pattern of the conductive material 730 after the conductive material 730 is deposited and etched on a bulge structure 720 with a thickness of 1 μm and an inclination slope of 14 degrees. Therefore, the pattern of the touch sensor electrodes forming on the junction of the bulge structure (ex., decoration layer) and the surface of the substrate may not qualify with a predetermined design. Moreover, when there is a strong acting force, such as a strong adhesion force, between the conductive material of the touch sensor electrodes and the material of the decoration layer, it would often cause the etching of the conductive material to be incomplete which referred to as a phenomenon of a film residue. Because of the film residue, a portion of the touch sensor electrodes disposed on the decoration layer may not able to be completely separated, thus causing short-circuit between the touch sensor electrodes.

### SUMMARY OF THE APPLICATION

The invention provides a touch panel capable of providing an easily patterned conductive element structure for enhancing a production yield of the touch panel.

A touch panel of the invention includes a substrate, a decoration layer and a plurality of conductive elements. The decoration layer is disposed on at least one side of the substrate and has an outer margin and an inner margin. The outer margin is closer to an edge of the substrate than the inner margin, and the inner margin is opposite to the outer margin. The inner margin is located between a reference line and the outer margin, and the reference line is at least 20 μm away form the inner margin. The conductive elements are disposed on the substrate, and include at least two cross-interface portions covering the decoration layer and a region on the substrate without the decoration layer. In a region outward of the reference line to the outer margin of the decoration layer, a distance between two cross-interface portions adjacent to each other includes a first distance, and in a region inward of the reference line towards a central direction of the substrate, a distance between two cross-interface portions adjacent to each other includes a second distance, and the first distance is greater than the second distance. The conductive elements at least construct a plurality of touch sensing units, and each touch sensing unit is used to form a capacitance coupling.

Another touch panel of the invention includes a substrate, a decoration layer and a plurality of conductive elements. The decoration layer is disposed on at least a side of the substrate. The decoration layer has a multi-layer structure, and an outermost lost layer structure away from the substrate in the multi-layer structure has an outer margin and an inner margin. The outer margin is closer to an edge of the substrate than the inner margin. Wherein, the inner margin is located between the outer margin and a reference line, and the reference line is at least 20 μm apart from the inner margin. The conductive elements are disposed on the substrate, and include at least two cross-interface portions. The cross-interface portions cover the decoration layer and a region on the substrate without the decoration layer. In a region outward of the reference line to the outer margin of the decoration layer, a distance between two cross-interface portions adjacent to each other includes a first distance, and in region inward of the reference line towards a central direction of the substrate, a distance between two cross-interface portions adjacent to each other includes a second distance, and the first distance is greater than a second distance. The conductive elements at least construct a plurality of touch sensing units, and each touch sensing unit is adapted to be used to form a capacitance coupling.

Yet another touch panel of the invention includes a substrate, a light resistant layer and a plurality of conductive elements. The light resistant layer is disposed on the substrate to form a budge structure, and the light resistant layer includes at least one layer structure. The conductive elements are disposed on the substrate, and include at least two cross-interface portions covering the light resistant layer and a region on the substrate without the light resistant layer. The at least one layer structure of the light resistant layer includes a contacting surface contact with the cross-interface portions, and an interaction between the contacting surface and the cross-interface portions is greater than an interaction between the substrate and the cross-interface portions. At least in a coverage of the contacting surface, a distance between two cross-interface portions adjacent to each other is greater than or equal to 35 μm. The conductive elements at least construct a plurality of touch sensing units, and each touch sensing unit is adapted to be used to form a capacitance coupling.

According to the foregoing, in the invention, the interval between the cross-interface portions of the conductive elements is adjusted, so that the two cross-interface portions adjacent to each other contacted on the decoration layer (light resistant layer) have a sufficient spacing therebetween. Therefore, even if the conductive elements is continuously deposited on both of the substrate and the bulge decoration layer (light resistant layer), a short-circuit due to a film residual phenomenon is not prone to occur between the cross-interface portions adjacent to each other, or, a disconnection of the cross-interface portions is avoided from occurring near the inner margin of the decoration layer (light resistant layer). Namely, the touch panel of the embodiment of the invention may ensure an electrical independence of each conductive pattern while having an ideal quality. At the same time, a configuration of the decoration layer (light resistant layer) may also be used to conceal elements in the device which are not wanted to be seen or light and thereby beautify an appearance of the touch panel.

In order to make the aforementioned and other features and advantages of the present application more comprehensible, several embodiments accompanied with figures are described in detail below.

### BRIEF DESCRIPTION OF THE DRAWINGS

The accompanying drawings are included to provide a further understanding of the application, and are incorporated in and constitute a part of this specification. The drawings illustrate embodiments of the application and, together with the description, serve to explain the principles of the application.

FIG. 1 is a partial schematic diagram illustrating a touch panel according to a first embodiment of the invention.

FIG. 2 is a schematic perspective view of the touch panel in FIG. 1.

FIG. 3 is a schematic diagram illustrating a touch panel according to another embodiment of the invention.

FIG. 4A and FIG. 4B are a schematic top view and a partial schematic top view illustrating a touch panel according to a second embodiment of the invention.

FIG. 5A is a schematic cross sectional view illustrating the touch panel in FIG. 4B along a profile line I-I′.

FIG. 5B is a schematic cross sectional view illustrating the touch panel in FIG. 4B along a profile line II-II′.

FIG. 6 a schematic cross sectional view illustrating a touch panel according to a third embodiment of the invention.

FIG. 7 and FIG. 8 are partial schematic top views illustrating two regions of a touch panel according to a fourth embodiment of the invention.

FIG. 9 and FIG. 10 are a schematic top view and a partial schematic top view illustrating a touch panel according to a fifth embodiment of the invention.

FIG. 11 is a schematic cross sectional view illustrating another touch panel according the fifth embodiment of the invention.

FIG. 12 is a schematic diagram illustrating an etching defect of a conductive material occurred in a conventional touch panel.

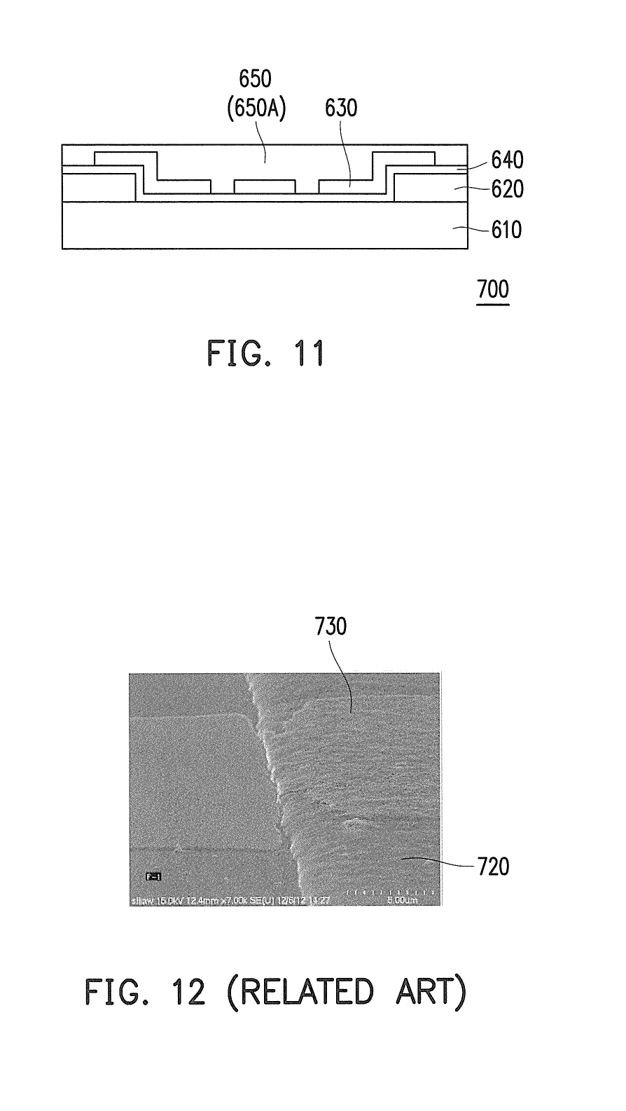

### DETAILED DESCRIPTION OF DISCLOSED EMBODIMENTS

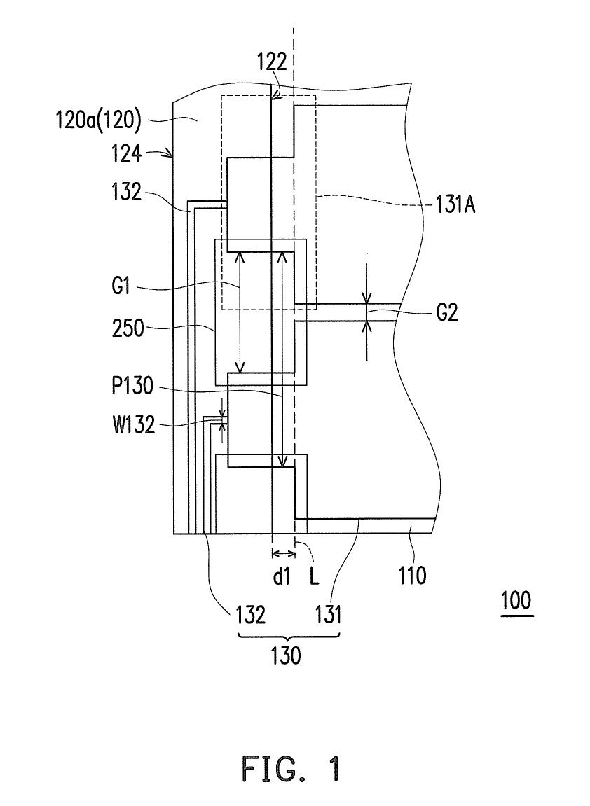

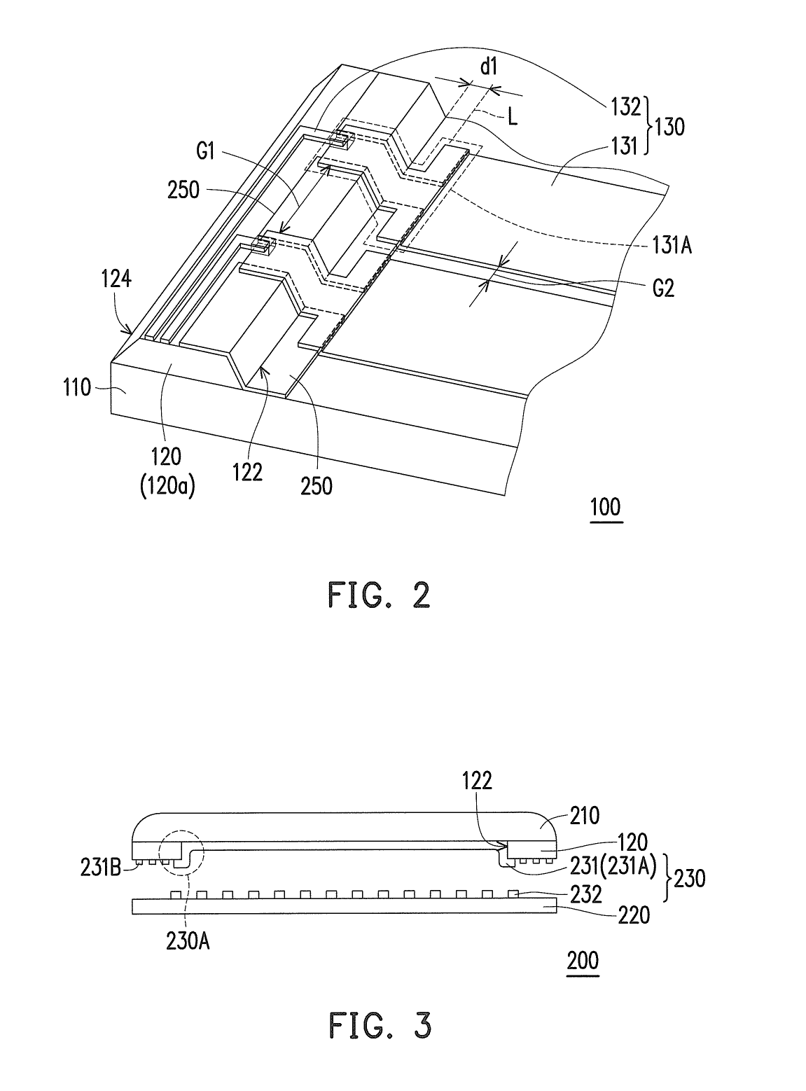

FIG. 1 is a partial schematic diagram illustrating a touch panel according to a first embodiment of the invention, and FIG. 2 is a schematic perspective view of the touch panel in FIG. 1. Referring to FIG. 1 and FIG. 2, a touch panel 100 includes a substrate 110, a decoration layer 120 and a plurality of conductive elements 130. The substrate 110 may be a rigid transparent substrate, such as a glass substrate, or may be a flexible transparent substrate, such as a plastic substrate, but is not limited thereto. A material of the decoration layer 120 may include at least one of a ceramic, a diamond-like carbon, an organic material, an organic inorganic hybrid compound, or a mixture of an organic material and an inorganic material, but not limited thereto. For example, the decoration layer 120 can be photosensitive resin, such as photoresist, or non-photosensitive resin, such as ink. The conductive elements 130 are made of a conductive material, which includes a transparent conductive material, such as indium tin oxide (ITO), indium-zinc oxide (IZO), gallium zinc oxide (GZO), carbon nanotube-based thin films, metal mesh, metal nanowires, such as silver nanowires, or other high conductive materials, but not limited thereto. In the present embodiment, the conductive elements 130 construct a plurality of touch sensing units 131 and a plurality of connecting wires 132. The touch sensing units 131 are adapted to be used to form capacitance couplings; the connecting wires 132 are electrically connected to at least a portion of the touch sensing units 131 so as to transmit signals. In the present embodiment, the touch sensing units 131 is made of ITO, and the connecting wires 132 is made of copper or other highly conductive materials.

In terms of a touch device integrated with display function, the touch panel 100 may have a light transmissive region and a light resistant region. The light transmissive region is corresponded to a display element such as a liquid crystal display element or an organic light-emitting diode display device, and the light resistant region is corresponded to a region disposed with non-display elements that requires to be concealed, and this type of elements, for example, may be the visible connecting wires 132. In order to achieve a maximization of a display region in an electronic device, demands for a narrow border has growingly increased, in which the visible connecting wires 132 are usually disposed at a peripheral region of the substrate 110. Even more, the visible connecting wires 132 can be only disposed on one of the sides of the substrate 110. Based on the same factors, the light resistant region is also usually configured in at least one side of the touch panel 100 so as to be corresponded to the decoration layer 120 located on at least one side of the substrate 110. The decoration layer 120 is made of a light resistant material, which is defined as a material deemed to render a light lost when the light passes through an interface thereof, up to and including complete opacity, and is used to conceal elements or light not wanted to be seen. For example, light resistant material may be a substantially opaque material, or a light-absorbing but translucent material such as a coated or painted material. Moreover, when a surface of a region disposed with the decoration layer 120 on the substrate 110 has a difference in elevation with a surface of an adjacent region of the substrate 110, the region disposed with the decoration layer 120 may be referred to as a thick portion, and the adjacent region may be referred to as a thin portion.

The conductive elements 130 are disposed on the substrate 110 and the decoration layer 120, thereby include at least two cross-interface portions 131A covering the decoration layer 120 and a region on the substrate 110 without the decoration layer 120. As shown in FIG. 1, the cross-interface portions 131A are substantially a portion of the touch sensing units 131. The conductive elements 130 invisible by human eyes may be located corresponding to the light transmissive region of the touch panel 100 and cover the substrate 110. Further, in order to ensure the touch function enabling around the light transmissive region or to increase the touch function at certain area of the light resistant region, the touch sensing units 131 may cover beyond the area of the light transmissive region so as to cover a portion of the decoration layer 120. When the conductive elements 130 include a metal mesh structure and are located corresponding to the light transmissive region, in a more favorable embodiment, the metal mesh structure including metal with a linewidth less than 5 μm.

In the present embodiment, the decoration layer 120 may have an inner margin 122 and an outer margin 124 opposite to the inner margin 122 and adjacent to an edge of the substrate 110. A reference line L may be defined as being from the inner margin 122 with a distance d1 of at least 20 μm towards a center of the substrate 110; that is, the inner margin 122 is located between the reference line L and the outer margin 124, and the reference line L is at least 20 μm apart from the inner margin 122. A distance between the two cross-interface portions 131A adjacent to each other at a region extended outward of the reference line L includes a first distance G1, and at a region extended inward of the reference line L includes a second distance G2, wherein the first distance G1 is greater than the second distance G2. As such, electrical independence between the cross-interface portions 131A may certainly be maintained in a patterning process of forming the conductive elements 130. In all embodiments of the invention, a direction outward of the reference line L is referred to a direction from reference line L towards the outer margin 124 of the decoration layer 120, and a direction inward of the reference line L is referred to a direction from the reference line L towards the center of the substrate 110.

As shown in FIG. 2, the decoration layer 120 forms a bulge thick portion on the substrate 110, and a region on the substrate 110 inward of the inner margin 122 of the decoration layer 120 may be referred to a thin portion. In a process of using lithography and etching methods to produce the conductive elements 130, when a photoresist is coated at the substrate 110 having the thick portion, a thicker photoresist portion may be constructed at an intersection of the thick portion and the thin portion, and thereby influence a uniformity of a photoresist exposure. Under a condition when an exposure value compensation amount is set to be insufficient, the thicker photoresist may remain on the material of the conductive elements 130 owing to insufficient exposure, then the two cross-interface portions 131A adjacent to each other that are predetermined to be separated may have a short-circuit.

In the present embodiment, the decoration layer 120 may be a black decoration layer 120a, wherein compositions of the black decoration layer 120a may include carbon black, chromium or chromium oxide, 3-methoxybutyl acetate, cyclohexanone, n-butyl acetate, propyleneglycol monomethyl ether acetate, acrylic resin and crosslinking agent, but the invention is not limited thereto. A conductive material constructing the conductive elements 130 may be deposited in the thick portion (the region with decoration layer 120) and the thin portion (the region without the decoration layer 120) via sputtering, but is not limited to, and when an interaction, such as acting force, between the conductive material and the decoration layer 120 is strong, for example, when the material of the conductive elements 130 includes indium tin oxide and the decoration layer 120 is the black decoration layer 120a, a surface energy of the black decoration layer 120a may enable a better adhesion between the black decoration layer 120a and the indium tin oxide. Therefore, in the process of forming the conductive elements 130 by patterning the conductive material, the conductive material predetermined to be removed is prone to occur an incomplete etching phenomenon, thus causing part of the conductive material to remain on the black decoration layer 120a. In order to avoid the residual conductive material from causing a short-circuit between the conductive elements 130 adjacent to each other, in the touch panel 100 of the present invention, the first distance G1 is required to be wide enough so as to provide enough line impedance between adjacent conductive elements 130 predetermined to be insulated from each other.

In one embodiment, when an inner region extended inward of the reference line L is disposed corresponding to a display area of a display panel, in order to prevent a user from being aware of the existence of the second distance G2, a size of the second distance G2 may be designed as at least maintaining the separation between the conductive elements 130, and often not greater than 30 μm. However, when the two cross-interface portion 131A adjacent to each other configure at the location of the decoration layer 120 with the aforementioned interval size, the short-circuit between the conductive elements 130 is most likely to be generated due to part of the conductive material is remained at the thicker photoresist portion or due to the conductive material is uneasy to be removed from the black decoration layer 120a. Therefore, the design of the present embodiment renders the first distance G1 to be greater than the second distance G2, and even renders the first distance G1 to be greater than 35 μm, so as to effectively avoid the conductive material from improperly remaining on the decoration layer 120 or a region nearby the inner margin 122 of the decoration layer 120 that cause a short-circuit between the conductive elements 130.

Moreover, in the present embodiment, a maximum size of the first distance G1 may be determined from a pitch P130 of the conductive elements 130 at an outer side the reference line L and a size of a linewidth W132 of the connecting wires 132. For example, the size of the first distance G1 may be increased to not greater than a value of subtracting the linewidth W132 from the pitch P130. Namely, in an embodiment, the pitch P130 of the conductive elements 130 may be equal to a total sum of the linewidth W132 and the first distance G 1. Now, a width of each conductive element 130 at the region outside of the reference line L is substantially equal to the linewidth W132 of the connecting wires 132.

In some embodiments, the touch panel 100 may further include a plurality of separated insulating patterns 250 disposed between the conductive elements 130 and the decoration layer 120, so as to separate the decoration layer 120 and the interval between the two adjacent cross-interface portions 131A at the outward of the reference line L. Compositions of the insulating patterns 250 may include 3-methoxybutyl acetate, cyclohexanone, n-butyl acetate, propyleneglycol monomethyl ether acetate, acrylic resin and crosslinking agent, but not limited to such compositions, and the insulating patterns 250 also may be mainly made of other inorganic or organic insulating materials. In the present embodiment, an interaction between the conductive material, which is the material of the conductive elements 130, and the insulating patterns 250 can be less than an interaction between the decoration layer 120 and the conductive material. For example, an adhesion force between the insulating patterns 250 and ITO is less than an adhesion force between the decoration layer 120 and ITO; however, the insulating patterns 250 may still enable ITO to be effectively adhered for the process of depositing ITO thereon. Therefore, in the present embodiment, the configuration of the insulating patterns 250 may reduce a condition of having an incomplete etching when conductive material is patterned to construct the conductive elements 130, so as to ensure the electrical independence between the conductive elements 130 in need of electrical insulation.

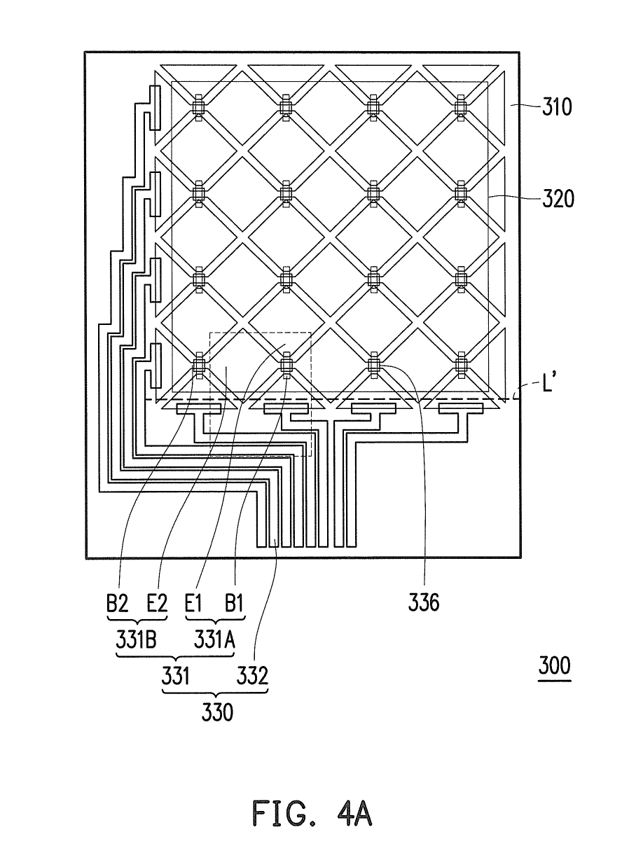

Moreover, in some embodiments, as shown in FIG. 3, a touch sensing panel 200 includes a first substrate 210, a second substrate 220, a decoration layer 120 and a plurality of conductive elements 230. The first substrate 210 may be a rigid transparent substrate, such as a glass substrate, or a flexible transparent substrate, such as a plastic substrate, but not limited thereto. The second substrate 220 may be a flexible transparent substrate, such as a transparent flexible thin film. The conductive elements 230 may include a first portion 231 and a second portion 232. The decoration layer 120 is disposed on the first substrate 210, and the first portion 231 of the conductive elements 230 is disposed on the first substrate 210 and the decoration layer 120, so as to include at least two cross-interface portions 230A, thereby stacked into a structure similar to the one shown in FIG. 2. The cross-interface portions 230A continuously cover the decoration layer 120 and a region on the first substrate 210 without the decoration layer 120. The second portion 232 of the conductive elements 230 is disposed on the second substrate 220. In one of the embodiments, the first portion 231 of the conductive elements 230 may comprise a part of a touch sensing unit 231A including a first axis conductive unit, and a plurality of connecting wires 231B electrically connected to the part of a touch sensing unit 231A. The second portion 232 may comprise the other part of the touch sensing unit 231A including a second axis conductive unit for forming a capacitance coupling with the first portion 231 of the conductive elements 230, and a plurality of connecting wires (not shown) electrically connected to the other part of a touch sensing unit 231A.

In the present embodiment, a reference line L similar to the one shown in FIG. 1 and FIG. 2 may be defined from the inner margin 122 of the decoration layer 120 with a distance d1 of at least 20 μm towards a direction away from the outer margin 124. A distance between two adjacent cross-interface portions 230A may include a first distance G1 in a region outward of the reference line L, and a second distance G2 in a region inward of the reference line L, wherein the first distance G1 is greater than the second distance G2. As a result, in the patterning process for forming the conductive elements 230, electrical independence may surely be maintained between the cross-interface portions 230A.

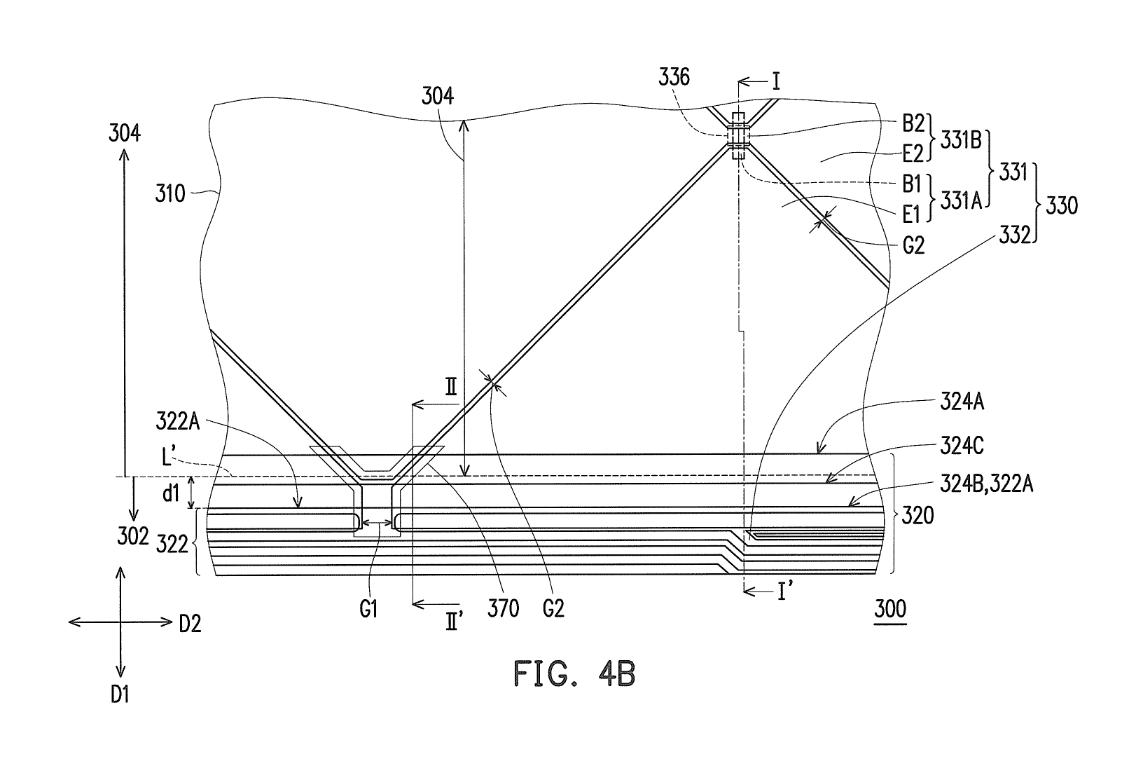

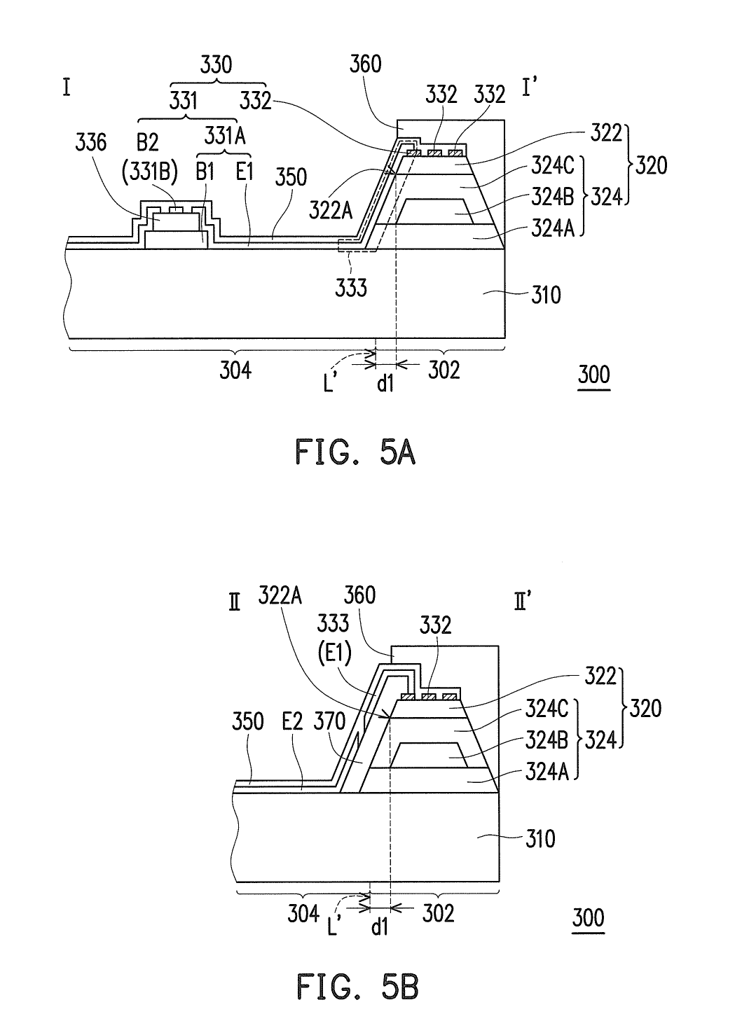

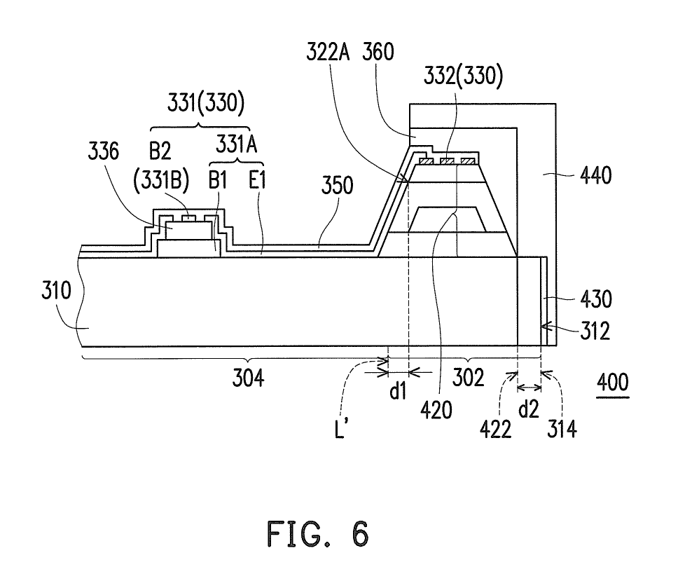

Structures of the conductive elements 230 and the decoration layer 120 in the above embodiment are only provided as example for the description purposes, and the invention is not limited thereto. For example, FIG. 4A and FIG. 4B are a schematic top view and a partial schematic top view illustrating a touch panel according to a second embodiment of the invention. FIG. 5A is a schematic cross sectional view illustrating the touch panel in FIG. 4B along a profile line I-I′; and FIG. 5B is a schematic cross sectional view illustrating the touch panel in FIG. 4B along a profile line II-II′. Referring to FIG. 4A, FIG. 4B and FIG. 5A at the same time, a touch panel 300 includes a substrate 310, a decoration layer 320, a plurality of conductive elements 330, an insulating layer 350 and a protective layer 360. The decoration layer 320 is disposed on at least one side of the substrate 310. The conductive elements 330 construct a plurality of touch sensing units 331 and connecting wires 332. The touch sensing units 331 are adapted to be used to form a capacitance coupling; and the connecting wires 332 are disposed on the decoration layer 320 and electrically connected to at least a portion of the touch sensing units 331 so as to transmit signals. The touch sensing units 331 and the connecting wires 332 may be made of a same material or different materials. In addition, materials related to the substrate 310 and conductive elements 330 are already disclosed in the previous embodiment, and thus are not to be repeated herein.

The insulating layer 350 may be an anti-reflective optical film, in which the anti-reflective optical film may selectively cover the conductive elements 330 or be disposed between the conductive elements 330 and the substrate 310, and are mainly used for improving an optical uniformity, so as to reduce a visibility of the touch sensing units 331. Therefore, the anti-reflective optical film 350 is at least disposed at a transmissive region of the touch panel 300. In an embodiment, the anti-reflective optical film 350 may be an insulating material having refractivity similar to that of a conductive material used to make the touch sensing units 331. In an embodiment, the anti-reflective optical film 350 may be a multi-layer structure covering the conductive elements 330, in which a refractivity of each layer of the multi-layer structure becomes lower as being closer to the substrate 310. In another embodiment, every two layers of the multi-layer structure have a refractivity change of low-high or high-low, and two of the layers being close to the touch sensing units 331 have a refractivity change of low-high-low or high-low-high with the touch sensing units 331. For example, the anti-reflective optical film 350 may be a two-layer structure, wherein a material of one layer thereof disposed on the touch sensing units 331 is silicon dioxide (SiO₂) with a refractivity lower than that of the touch sensing units 331, and material of the other layer thereof disposed on the silicon dioxide is silicon nitride (SiNx) with a refractivity higher than that of the silicon dioxide. Moreover, when the anti-reflective optical film 350 is the multi-layer structure, a planarization effect may be provided so as to facilitate the subsequent fabrication or combination of other stacked layers. A material of the anti-reflective optical film 350 may be selected from alumina (Al₂O₃), niobium oxide (Nb₂O₅), titanium dioxide (TiO₂), silicon nitride, silicon oxynitride, silicon dioxide, high refraction photoresist organic insulating material, high refraction hard coat or other transparent insulating material, and a laminated combination thereof, but not limited thereto. The protective layer 360 at least covers the connecting wires 332 made of conductive material with low electrical resistance, and is mainly used to avoid the connecting wires 332 oxidation. The protective layer 360, for example, may be made of an insulating material, such as organic insulating material, but the invention is not limited thereto.

As in contrast with the decoration layer 120, which is the single-layer structure, of the first embodiment, the decoration layer 320 of the present embodiment has a multi-layer structure, and an innermost layer structure thereof is an observed decoration layer, and in an outermost layer structure, a light shading material is included thereof. Wherein, the outermost layer structure is being referred to the structure in the decoration layer 320 most away from the substrate 310. The light shading material may include carbon black, chromium oxide, or other light resistant material with optical density larger than 3 and resistivity larger than 10⁶ ohm-m, but the invention is not limited thereto. In the present embodiment, the decoration layer 320 includes a black decoration layer 322 and a non-black decoration layer 324, wherein the black decoration layer 322 is the outermost layer structure of the decoration layer 320 far away from the substrate 310, and the non-black decoration layer 324 is located between the black decoration layer 322 and the substrate 310. The non-black decoration layer 324, starting from the substrate 310, sequentially includes a first white decoration layer 324A, a second white decoration layer 324B and a third white decoration layer 324C.

The black decoration layer 322 is mainly used for enhancing a light shading ability, and the compositions thereof are as described in the previous embodiment; and it is to be noted that, the color of the outermost layer structure of the decoration layer 320 in the present invention is not limited to black. Moreover, in an embodiment, the outermost layer structure of the decoration layer 320 further provides an effect of planarizing a surface of the decoration layer 320. The non-black decoration layer 324 may be a non-black light resistant ink, but not limited thereto. In other embodiments, the multi-layer structure of the decoration layer 320 includes at least two layer structures having different colors substantially in contrast with each other, such as black stacked with white or gray stacked with white, etc. The first white decoration layer 324A, the second white decoration layer 324B and the third white decoration layer 324C may be made of different materials or a same material, and compositions thereof may include titania, powder, resin and diluent, but not limited thereto. In the present embodiment, the first white decoration layer 324A and the third white decoration layer 324C commonly encapsulate the second white decoration layer 324B. Namely, these white decoration layers 324A, 324B, 324C arranged according to the size of widths, from large to small, are the first white decoration layer 324A, the third white decoration layer 324C and the second white decoration layer 324B, sequentially. Certainly, the invention is not limited to the stacking structure of the non-black decoration layer 324. In other embodiments, the non-black decoration layer 324 may adopt a single-layer structure or a multi-layer stacking structure according to different design requirement. Moreover, the black decoration layer 322 may also selectively be constructed by a multi-layer stacking structure.

In the present embodiment, the conductive elements 330 are disposed on the substrate 310 and the decoration layer 120, and include a plurality of first inductive series 331A and a plurality of second inductive series 331B. The first inductive series 331A and the second inductive series 331B are electrically independent from each other. Each first inductive series 331A includes a plurality of first electrodes E1 and a plurality of bridge electrodes B1, and each second inductive series 331B includes a plurality of second electrodes E2 and a plurality of connecting electrodes B2. In order to reduce impedance, the bridge electrodes B1 may be high temperature deposited indium tin oxide or narrow metal wires for connecting the first electrodes E1 in series along a first direction D1. Moreover, the connecting electrodes B2 connect the second electrodes E2 in series along a second direction D2, and the first direction D1 intersects the second direction D2. The first electrodes E1 and the second electrodes E2 adjacent to each other may form capacitance couplings for constructing the touch sensing units 331. Through the touch sensing units 331, when a conductive object, such as finger, approaches to or contacts with an operating surface of the substrate 310 opposite to the surface where the conductive elements 330 is disposed, coupling capacitances between the object and the touch sensing units 331 will establish, thereby cause a change in capacitance effects to detect the position of the object or the motion of the object by a self capacitance measurement method or a mutual capacitance measurement method. Furthermore, a first insulating pattern 336 is disposed at each intersection of the first inductive series 331A and the second inductive series 331B, so that the first inductive series 331A and the second inductive series 331B are electrically independent of each other. Herein, the first electrodes E1 and the second electrodes E2, for example, are taken as diamond structures for an illustration purpose, but the invention is not limited thereto.

The conductive elements 330 include at least two cross-interface portions 333 covering the decoration layer 320 and a region on the substrate 310 without the decoration layer 320. In the present embodiment, the cross-interface portion 333 may be a terminal end of the first inductive series 331A or a terminal end of the second inductive series 331B. Or, the terminal end of the first inductive series 331A and the terminal end of the second inductive series 331B are both the cross-interface portions 333. In other words, the cross-interface portions 333 may construct a portion of the first inductive series 331A and a portion of the second inductive series 331B where are most close to the decoration layer 320. In the present embodiment, the decoration layer 320 is disposed on the periphery of the substrate 310, and it is to be understood that, even though FIG. 4B illustrates the second inductive series 331B only covering the first white decoration layer 324A and not covering to the outermost layer structure (black decoration layer 322) of the decoration layer 320; however, in a top view (not shown) of another portion of the touch panel 300, the terminal end of the second inductive series 334 covers to the outermost layer structure of the decoration layer 320, whereas the first inductive series 332 only covers the first white decoration layer 324A.

FIG. 5A and FIG. 5B show that, the decoration layer 320 constructs a bulge structure on the substrate 310, as such, when fabricating the conductive elements 330 via lithography and etching, the problem of prone to the residue of conductive material due to uneven photoresist at the intersection of the thicker portion and the thin portion so that the two adjacent conductive elements 330 which are predetermined to be separated from each other, are short-circuit, as described by the previous embodiment, may be encountered. Moreover, when the surface of the decoration layer 320 is not constructed of a smooth line or a curve, but a stair like thick portion, especially, when a inner margin of one of the multiple layers of the decoration layer 320 corresponds to a subsidence portion of an adjacent layer, a junction of the two stacked layers in a ladder manner may correspond to a photoresist thick portion after the photoresist is coated on this substrate 310 having the decoration layer 320, so that a short-circuit is prone to forming due to the residue of conductive material. Moreover, when an interaction, such as adhesion, between a material of the outermost layer structure of the decoration layer 320 and the conductive material of conductive elements 330 is stronger, the conductive material may be unable to be completely removed and remained on the decoration layer 320, thereby resulting in the problem of short-circuit.

Of solving the aforementioned problem, the present embodiment further defined a reference line L′, which is located at a distance d1 of at least 20 μm apart from an inner margin 322A of the outermost layer structure of the decoration layer 320 and towards to the center of the substrate 310. A distance between two adjacent cross-interface portions 333 may include a first distance G1 outward of the reference line L′ and a second distance G2 inward of the reference line L′. The first distance G1 is greater than the second distance G2; or, the first distance G1 is greater than 35 μm. As such, in the process of fabricating the conductive elements 330, the electrical independence is ensured to be maintained between the cross-interface portions 333. In the present embodiment, the first distance G1 of the two adjacent cross-interface portions 333 is defined by two adjacent first electrodes E1 located at the terminal end of each series disposed on the outermost layer structure of the decoration layer 320; moreover, the second distance G2 of the two adjacent cross-interface portions 333 is then defined by a first electrode E1 and a second electrode E2 adjacent to each other. Namely, in the present embodiment, the two electrodes defining the first distance G1 may be different from the two electrodes defining the second distance G2. In the present invention, it is mainly to adjust the distance between the adjacent cross-interface portions 333 at different locations, so as to avoid an occurrence of adverse effects during the deposition or the patterning processes of the conductive material.

In the present embodiment, the non-black decoration layer 324 has a portion located at an inner side 304 of the reference line L′ and the other portion located at an outer side 302 of the reference line L′, but the invention is not limited thereto. In other embodiments, the non-black decoration layer 324 may completely be located in the outer side 302 of the reference line L′, or an inner margin of the non-black decoration layer 324 may be aligned to the reference line L′. According to the same reason as the previous embodiment, the size of the second distance G2 of the present embodiment may be designed as to at least maintaining the separation of the conductive elements 330, but not greater than 30 μm. Moreover, in the present embodiment, as shown in FIG. 4B and FIG. 5B, the touch panel 300 may selectively be further configured with a plurality of separated second insulating patterns 370, which are disposed between the conductive elements 330 and the decoration layer 320, and are at least separated an interval between two adjacent cross-interface portions 331A at the outer side 302 of the reference line L′ from the decoration layer 320. In one of the embodiments, shapes of the second insulating patterns 370 may almost be greater than a shape of the interval between the two adjacent cross-interface portions 331A, as shown in FIG. 4B, the second insulating patterns 370 may be Y-shaped with a covering range larger than the interval between the two adjacent cross-interface portions 331A. Namely, partial conductive elements 330 near by the interval between the two adjacent cross-interface portions 331A formed on the second insulating patterns 370 as shown in FIG. 5B. The material of the second insulating patterns 370 may be referred to the material recorded for the insulating patterns 250 disclosed in the first embodiment, and thus is not to be repeated herein. Through configuring the second insulating patterns 370, a condition of incomplete etching when the conductive material is patterned conductive material to construct the conductive elements 330 may be reduced, so as to ensure the electrical independence between the conductive elements 330.

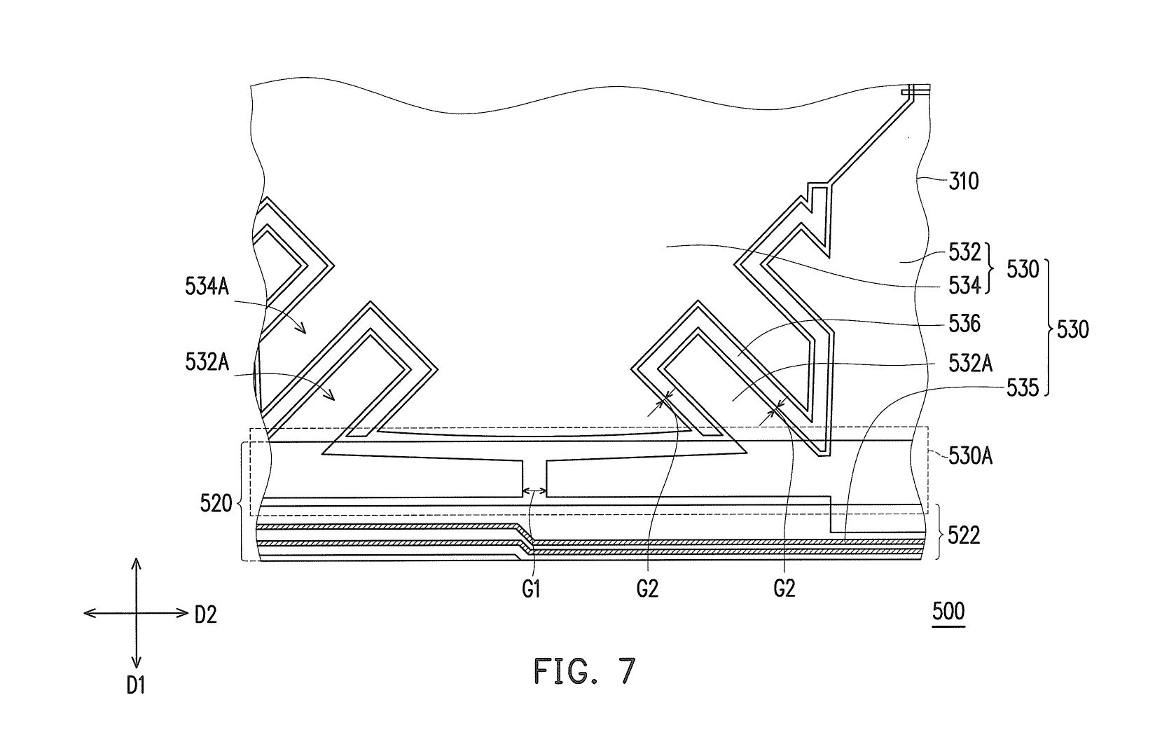

When the touch panel 300 is fabricated with the components, such as the decoration layer 320 and the conductive elements 330, on the substrate 310 after the substrate 310 is cut into a predetermined size, the edge of the decoration layer 320 and the edge of the substrate 310 may be aligned with each other, but the invention is not limited thereto. For example, FIG. 6 a schematic cross sectional view illustrating a touch panel according to a third embodiment of the invention. Referring to FIG. 6, a touch panel 400 is generally similar to the touch panel 300, and thus the same or the similar components in the two embodiments are to be represented with the same or similar element symbols. In the present embodiment, the touch panel 400 includes the substrate 310, a decoration layer 420, the conductive elements 330, the insulating layer 350, the protective layer 360, a strengthening layer 430 and a light shielding layer 440. The light shielding layer 440 includes a light resistant material, which may be selected from the material of the decoration layer 320 in the previous embodiment, or may be selected from other light resistant coating or element, but not limited thereto.

A fabricating method of the touch panel 400, for example, is to firstly fabricate the components, such as the decoration layer 420, the conductive elements 330, the anti-reflective optical film 350 and the protective layer 360, on a mother substrate. Next, the mother substrate formed with the aforementioned components is cut into a required size, so as to form the substrate 310 having the aforementioned components thereon. However, a sidewall 312 of the substrate 310 may become relatively fragile due to the steps of cutting and splitting. Therefore, in the present embodiment, the strengthening layer 430 is disposed on the sidewall 312 of the substrate 310 for enhancing the strength of the substrate 310. The strengthening layer 430 may include a material such as UV resin or resin mixed with glass fiber and/or carbon nanotube, but the invention is not limited thereto.

Moreover, an edge 422, also called as the outer margin in the other embodiment, of the decoration layer 420 and an edge 314 of the substrate 310 may be separated with a gap d2 apart. Since the gap d2 usually does not correspond to a display region of a display element, in order to avoid a leakage of light through this gap d2 and to provide a more favorable display quality, or in order to have a more ideal appearance, the light shielding layer 440 at least covers a region between the edge 422 of the decoration layer 420 and the edge 314 of the substrate 310, namely, covers across the gap d2. In addition, the light shielding layer 440 may further partially or completely cover on the strengthening layer 430, so as to provide a more favorable light leakage preventing effect.

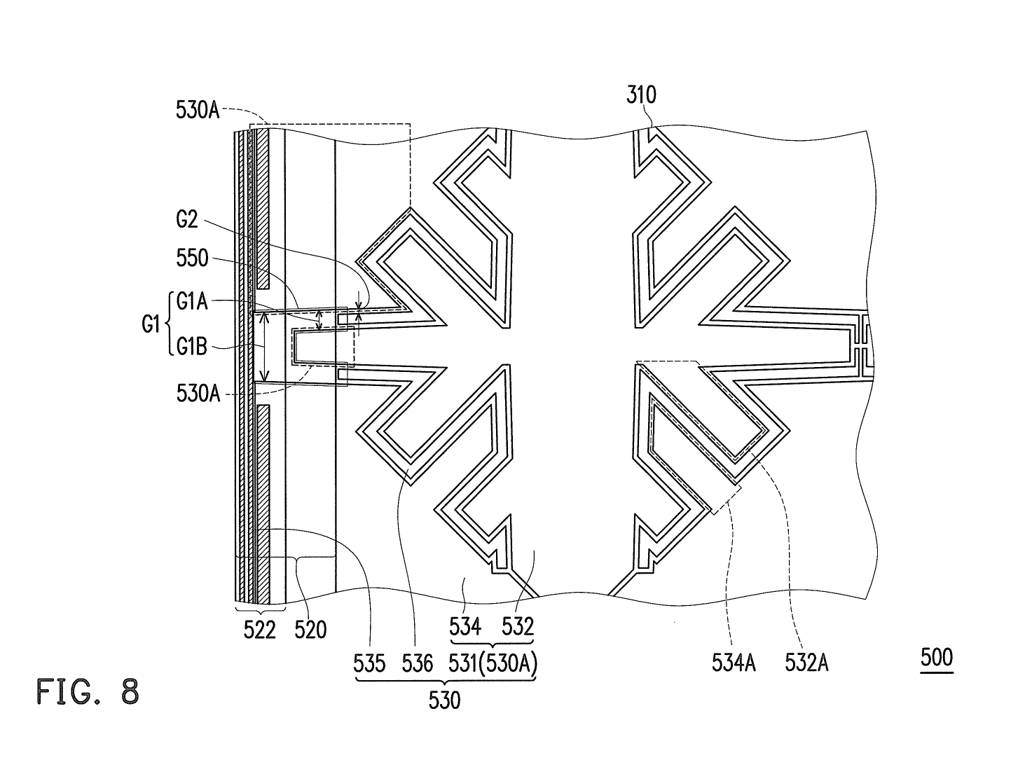

FIG. 7 and FIG. 8 are partial schematic top views illustrating two regions of a touch panel according to a fourth embodiment of the invention. Referring to FIG. 7 and FIG. 8, a touch panel 500 is similar to the touch panel 300 of the previous embodiment, and therefore, the same or the similar components in the two embodiments are to be represented with the same or similar element symbols. The touch panel 500 includes the substrate 310, a light resistant layer 520 and a plurality of conductive elements 530. The light resistant layer 520 is disposed on at least one side of the substrate 310 to form a bulge structure, thereby correspondingly concealing the elements or light not wanted to be seen. The light resistant material of the light resistant layer 520 can be referred to the previous embodiments, and thus is not to be repeated herein. The conductive elements 530 mainly cover a region on the substrate 310 without the light resistant layer 520 and partially disposed on the light resistant layer 520, in which the parts in the conductive elements 530 continuously covering the light resistant layer 520 and a region on the substrate 310 without the light resistant layer 520 are defined as cross-interface portions 530A. Namely, the light resistant layer 520 comprises a contacting surface contacted with the at least two cross-interface portions 530A. In the present embodiment, the conductive elements 530 include at least two cross-interface portions 530A. The conductive material of the conductive elements 530 can be referred to the previous embodiments, and is not to be repeated herein. In the present embodiment, the conductive elements 530 includes a plurality of touch sensing units 531, a plurality of auxiliary electrodes 536 and a plurality of connecting wires 535.

In the present embodiment, the light resistant layer 520 has a multi-layer structure, and an interaction between an outermost layer structure 522 and a cross-interface portions 530A is stronger than an interaction between each of the rest layers of the light resistant layer 520 and the cross-interface portions 530A and between the substrate 310 and the cross-interface portions 530A. In some embodiments, the interaction, such as adhesion, may be varied due to process of different conditions; for instance, a high temperature process may cause the outermost layer structure 522 to have a much stronger adhesion exerted to the conductive material. According to the above, since the light resistant layer 520 constructs a bulge structure on the substrate 310 and has a heterogeneous material (the outermost layer structure 522 of the present embodiment) that exerts a stronger interaction to the cross-interface portions 530, in the depositing and patterning processes of the conductive material, the previously described defects, such as a short-circuit phenomenon or an etching disconnection, are all possible to occur. Therefore, in the present embodiment, within a distribution range of the light resistant layer 520, at least within a range of the cross-interface portions 530A contacted with the outermost layer structure 522 of the light resistant layer 520, a distance between the two adjacent cross-interface portions 530A is greater than or equal to 35 μm. In a favorable embodiment, starting from a point, which is at least 20 μm inward of an inner margin of the outermost layer structure 522 of the light resistant layer 520, to an outer margin of the outermost layer structure 522, a distance G1 between the two adjacent cross-interface portions 530A is greater than or equal to 35 μm.

Specifically, the conductive elements 530, for example, include a plurality of first inductive series, a plurality of second inductive series and a plurality of auxiliary electrodes 536. Referring to FIG. 7 and FIG. 8, only a first electrode 532 in first inductive series and a second electrode 534 in the second inductive series are illustrated for the purpose of representation. It can be understood that, the first electrodes 532 are connected in series along the first direction D1; and the second electrodes 534 are connected in series along the second direction D, and the first direction D1 intersects the second direction D2. Wherein, the first electrode 532 and the second electrode 534 adjacent to each other may form a capacitance coupling, so as to construct a touch sensing unit 531. The first electrode 532 includes a plurality of first branches 532A directing toward the second electrode 534 adjacent thereof, the second electrode 534 includes a plurality of second branches 534A directing toward the first electrode 532 adjacent thereof, and the first branches 532A and the second branches 534A are arranged in a staggered manner. The auxiliary electrodes 536 are disposed between the first electrodes 532 and the second electrodes 534 adjacent to each others, and the first electrodes 532, the second electrodes 534 and the auxiliary electrodes 536 are all electrically insulated with one another. A gap between each auxiliary electrode 536 and the first electrode 532 or the second electrode 534 adjacent thereof is smaller than 30 μm. With this, a visibility of the patterns of the touch sensing units 531 is reduced, or a sensitivity of the touch sensing units 531 is assisted. In the present embodiment, the auxiliary electrodes 536 are only disposed in a region inward of the inner margin of the light resistant layer 520, and are not in contacted with the light resistant layer 520, which is helpful in the deposition and the patterning process of the conductive material.

Specifically, in FIG. 7, the first electrodes 532 are formed on the substrate 310 and extending along the first direction D1 toward a side of the substrate 310 so as to cover the outermost layer structure 522 of the light resistant layer 520. Whereas, the second electrodes 534 and the auxiliary electrodes 536 are not covering on the outermost layer structure 522. The portions of adjacent first electrodes 532 on the outermost layer structure 522 are spaced apart with a distance greater than 50 μm. Moreover, in the present embodiment, the adjacent two cross-interface portions 530A are spaced apart with a second distance G2 at a region without the light resistant layer 520, and the adjacent two cross-interface portions 530A on the rest of the light resistant layer 520, rather than the outermost layer structure 522, have a first distance G1 greater than the second distance G2. In FIG. 8, the second electrodes 534 extend along the second direction D2 toward another side of the substrate 310 and cover on the outermost layer structure 522 of the light resistant layer 520, whereas the first electrodes 532 and the auxiliary electrodes 536 do not cover the outermost layer structure 522. On the light resistant layer 520, an interval G1A between the first electrodes 532 and the second electrodes 534 is greater than 35 μm, and an interval G1B between two adjacent second electrodes 534 is at least 50 μm. Moreover, in the present embodiment, in the region inward of the inner margin of the light resistant layer 520, the two conductive elements adjacent to each other, such as the second electrodes 534 and the auxiliary electrodes 536, are spaced apart with the second distance G2, and the second distance G2 is smaller than the interval G1A and the interval G1B.

In some embodiments, as shown in FIG. 8, the touch panel 500 may selectively be disposed with a plurality of separated insulating patterns 550, and the separated insulating patterns 550 are disposed between the conductive elements 530 and the light resistant layer 520, so as to at least separate an interval between the two cross-interface portions 530A adjacent to each other from the heterogeneous material of the light resistant layer 520. Wherein, an interaction between the insulating patterns 550 and the conductive material used to make the conductive elements 530 is smaller than an interaction between the decoration layer 520 and the conductive material. The material of the insulating patterns 550 may be referred to the material of the insulating patterns 250 disclosed in the first embodiment, and thus is not to be repeated herein. Through configuring the insulating patterns 550, the problem of causing a short-circuit phenomenon due to poor patterning may be improved, thereby enhancing a quality of the touch panel 500.

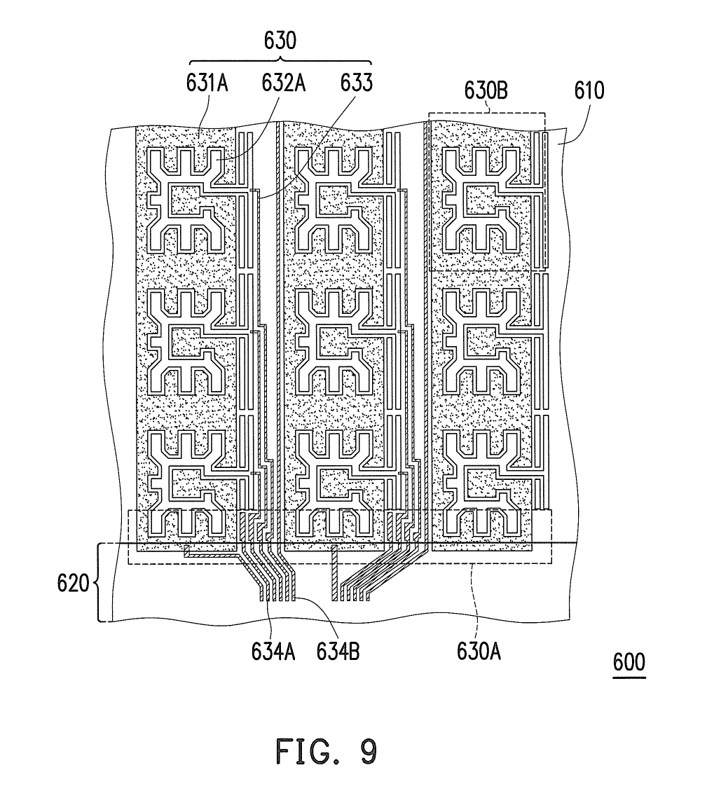

FIG. 9 and FIG. 10 are a schematic top view and a partial schematic top view illustrating a touch panel according to a fifth embodiment of the invention. A touch panel 600 includes a substrate 610, a light resistant layer 620 and a plurality of conductive elements 630. The light resistant layer 620 is disposed on the substrate 610 thereby forming a bulge structure, so as to correspondingly conceal the elements or light not wanted to be seen in the device. The light resistant material of the light resistant layer 620 is already recorded in the previous embodiments, and thus is not to be repeated herein. The conductive elements 630 mainly cover a region on the substrate 610 without the light resistant layer 620 and partially disposed on the light resistant layer 620, wherein at least one of the conductive elements 630 has cross-interface portions 630A (as shown in FIG. 10) which continuously cover the light resistant layer 620 and a region on the substrate 610 without the light resistant layer 620. The conductive elements 630 construct a plurality of touch sensing units 630B and a plurality of connecting wires 633, wherein the cross-interface portions 630A belong to a portion of the touch sensing units 630B and a portion of the connecting wires 633. In the present embodiment, the conductive elements 630 are all made of invisible conductive material, and the conductive material of the conductive elements 630 is already recorded in the previous embodiment, and thus is not to be repeated herein. In FIG. 9, for a convenience of marking the touch sensing units 630B, the illustration of the detail structure of the connecting wires 633 connected with the most right conductive element 630 is omitted to show.

In the present embodiment, the light resistant layer 620 is made of a heterogeneous material with a single-layer structure, an interaction between the heterogeneous material and the cross-interface portions 630A is stronger than an interaction between the substrate 610 and the cross-interface portion 630A. For example, a material of the cross-interface portions 630A may be indium tin oxide, and the heterogeneous material may be a black decoration layer with a stronger adhesion with the indium tin oxide. As mentioned above, since the light resistant layer 620 constructs a bulge structure on the substrate 610 and has the heterogeneous material that form a stronger interaction with the cross-interface portions 630A, in the depositing and patterning processes of the conductive material, the previously described defects, such as short-circuit or etching disconnection, are all possible to occur. Therefore, in the present embodiment, within a distribution range of the light resistant layer 620, at least within a range of the cross-interface portions 630A contacted with the light resistant layer 620, a distance between the adjacent two cross-interface portions 630A, for example, as a distance D13 shown in FIG. 10, is greater than or equal to 35 μm. In a favorable embodiment, starting from a point, which is at least 20 μm inward of an inner margin of the light resistant layer 620, to an outer margin of the light resistant layer 620, a distance between the two cross-interface portions 630A adjacent to each other is greater than or equal to 35 μm.

Specifically, the conductive element 630 includes a plurality of first electrodes 631A, a plurality of second electrodes 632A and a plurality of connecting wires 633. The first electrodes 631A may be connected into series having a same extending direction. In the present embodiment, the connecting wires 633 are respectively and electrically connected to the second electrodes 632A and the first electrodes 631A, and the first electrodes 631A and the second electrodes 632A are electrically insulated with each others. The first electrodes 631A and the second electrodes 632A adjacent thereof may form capacitance couplings and construct the touch sensing units 630B. Moreover, a shielded wire 634A connected to a reference potential may be disposed between the touch sensing units 630B of different serial groups. In the present embodiment, each connecting wire 633 may be correspondingly connected to one of second electrodes 632A to output signals. Furthermore, the connecting wire 633 may correspondingly connect to the series constructed by each first electrode 631A to transmit the signals.

The cross-interface portions 630A of the connecting wires 633 may include at least one bent portion 633B, and each bent portion 633B is disposed at the region on the substrate 610 without the light resistant layer 620, so that, among the connecting wires 633, a minimum distance W1 between the two outermost connecting wires 633 on the light resistant layer 620 is greater than a minimum distance W2 between the two outermost connecting wires 633 at the region on the substrate 610 without the light resistant layer 620. In one of the embodiments, N amounts of the touch sensing units 630B construct a same serial group, and a minimum width of the connecting wires 633 is M μm, whereas a distance from the bent portion 633B farthest away from an inner margin of the light resistant layer 620 to the inner margin of the light resistant layer 620 is at least N multiplied by M μm. As illustrated in FIG. 9, a same serial group is constructed by three touch sensing units 630B, and three serial groups are disposed on the substrate 610, but the invention is not limited thereto. With this, configurations of the bent portions 633B of the connecting wires 633 are controlled to facilitate an impedance compensation adjustment by changing the linewidth of the connecting wires 633 and spaces between the connecting wires 633. For example, the cross-interface portions 630A of at least a portion of the connecting wires 633 may include at least two different linewidths and at least two different spacings therebetween. As shown in FIG. 10, in the cross-interface portions 630A, each connecting wire 633 from a starting end, which is connected to the corresponding touch sensing unit 630B, to a terminal end may include a first linewidth W11, a second linewidth W12 and a third linewidth W13; and in the cross-interface portions 630A, a spacing between the connecting wires 633 adjacent to each other, from the starting end to the terminal end, may include a first spacing D11, a second spacing D12 and a third spacing D13. The part of the connecting wires 633 having the third linewidth W13 is disposed on the light resistant layer 620, and the part of the connecting wires 633 having the first linewidth W11 is disposed at the region on the substrate 610 without the light resistant layer 620. In order to make the patterning process of the connecting wires 633 easier, the third linewidth W13 is greater than the first linewidth W11, and the third spacing D13 is designed to be greater than the first spacing D11 and the second spacing D12. Moreover, when the third linewidth W13 is greater than the first linewidth W11, it is more conducive in avoiding the connecting wires 633 from having a disconnection nearby the inner margin of the light resistant layer 620. In order to reduce the visibility of the connecting wires 633, the second linewidth W12 may be designed as greater than the first linewidth W11 and the third linewidth W13. Furthermore, as shown in FIG. 10, in the cross-interface portions 630A, a shielding wire 634B may be disposed between the connecting wires 633 and the touch sensing units 630B, the shielding wire 634B is connected to a reference potential, such as a ground, and a width of the shielding wire 634B is at least 50 μm. Thereby, the signal interference between the connecting wires 633 and the touch sensing units 630B can be reduced.

As shown in FIG. 10, the first electrodes 631A and the connecting wires 633 are formed on the substrate 310 and extending toward a side of the substrate 310 to cover the light resistant layer 620, and thereby construct the cross-interface portions 630A. The first electrodes 631A and the adjacent connecting wires 633 keep a distance greater than 35 μm on the light resistant layer 620, and the two connecting wires 633 adjacent to each other also keep a distance greater than 35 μm on the light resistant layer 620. As a result, in the patterning process of the conductive material, the electrical independence between the cross-interface portions 630A may be ensured.

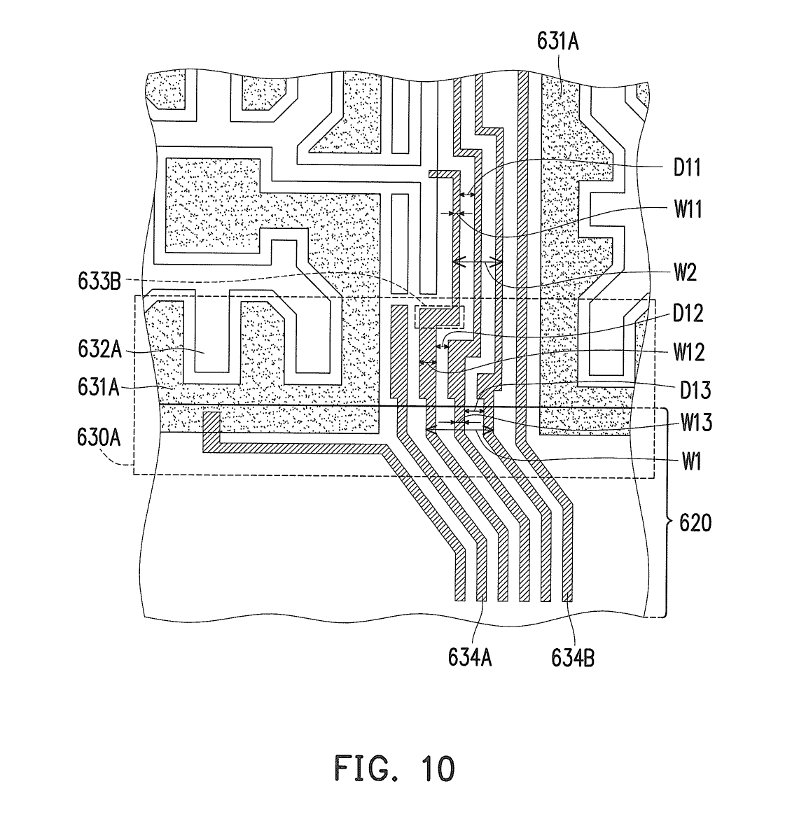

In some embodiments, in order to more effectively address the various problems caused by the bulge structure and material of the light resistant layer 620, the conductive material for making the conductive elements 630 may be deposited on a same material and then perform the subsequent etching. For example, a touch panel 700, as disclosed in FIG. 11, includes the substrate 610, the light resistant layer 620, the conductive elements 630, the overlay 640 and the insulating layer 650. The overlay 640 may be disposed on both of the substrate 610 and light resistant layer 620, so that the conductive material can be deposited on a same material. For example, a refractivity of the overlay 640 is similar to a refractivity of the substrate 610, such that a refractivity difference between the overlay 640 and the substrate 610 is smaller than 0.3. For example, the material of the overlay 640 may be silicon dioxide. The conductive material is deposited on the overlay 640, and then subsequently be etched into a plurality of conductive elements 630. Moreover, the insulating layer 650 may be selected from an anti-reflective optical film, a planarization layer 650A and a combination thereof. The anti-reflective optical film may cover the conductive elements 630 or be disposed between the substrate 610 and the conductive elements 630, so as to reduce the visibility of the patterns of the conductive elements 630. The material of the anti-reflective optical film is as previously described, and thus is not to be repeated. The planarization layer 650A covers the conductive elements 630, and a thickness of the planarization layer 650A is at least 0.8 μm so as to provide a planarization effect.

In summary, the touch panel in the embodiments of the invention has the cross-interface portions of the conductive elements separating at least a predetermined interval in the portion in contact with the light resistant layer (decoration layer). As a result, the short-circuit problem caused by the poor patterning of the conductive elements due to the bulge structure of the decoration layer (light resistant layer) or the etching disconnection problem due to the uneven deposition of the conductive material may all be solved. Therefore, the touch panel in the embodiments of the invention may have the ideal quality.

It will be apparent to those skilled in the art that various modifications and variations can be made to the structure of the application without departing from the scope or spirit of the application. In view of the foregoing, it is intended that the application cover modifications and variations of this application provided they fall within the scope of the following claims and their equivalents.

What is claimed is:

1. A touch panel comprising:
a substrate;
a decoration layer disposed on at least one side of the substrate, the decoration layer having an outer margin and an inner margin, the outer margin opposite to the inner margin and adjacent to an edge of the substrate, wherein the inner margin is located between a reference line and the outer margin, and the reference line is at least 20 μm apart from the inner margin; and
a plurality of conductive elements disposed on the substrate, the conductive elements comprising at least two cross-interface portions, the at least two cross-interface portions covering the decoration layer and a region on the substrate without the decoration layer;
wherein, a distance between the at least two cross-interface portions adjacent to each other comprises a first distance in a region outward of the reference line to the outer margin, and comprises a second distance in a region inward of the reference line, and the first distance is greater than the second distance;
wherein, the conductive elements at least construct a plurality of touch sensing units, and each touch sensing unit is used to form a capacitance coupling.

2. The touch panel as recited in claim 1, wherein the at least two cross-interface portions construct at least a portion of the touch sensing units.

3. The touch panel as recited in claim 1, wherein the conductive elements further construct a plurality of connecting wires electrically connected to at least a portion of the touch sensing unit, and the connecting wires are disposed on the decoration layer.

4. The touch panel as recited in claim 3, wherein at least a portion of the connecting wires covering the decoration layer and a region on the substrate without the decoration layer so as to be at least a part of the cross-interface portions.

5. The touch panel as recited in claim 4, wherein the at least a portion of the connecting wires comprises at least one bent portion, and each bent portion is disposed at the region on the substrate without the decoration layer, so that, in the connecting wires, a minimum distance on the decoration layer between outermost two connecting wires is greater than a minimum distance on the region of the substrate without the decoration layer between the outermost two connecting wires.

6. The touch panel as recited in claim 5, wherein N amounts of the touch sensing units construct a same serial group, a minimum width of the connecting wires is M μm, and a farthest distance from the at least one bent portion to the inner margin of the decoration layer is at least N multiplied by M μm.

7. The touch panel as recited in claim 5, wherein a shielding wire is disposed between the at least a portion of the connecting wires and the touch sensing units, the shielding wire is connected to a reference potential, and a width of the shielding wire is at least 50 μm.

8. The touch panel as recited in claim 5, wherein each of the at least a portion of the connecting wires comprises at least two different linewidths and at least two different spacings each between adjacent two of the at least a portion of the connecting wires.

9. The touch panel as recited in claim 8, wherein each of the at least a portion of the connecting wires, from a starting end connecting to the corresponding touch sensing unit to a terminal end, comprises a first linewidth, a second linewidth, and a third linewidth; and
the spacings between adjacent two of the at least a portion of the connecting wires, from the starting end to the terminal end, comprises a first spacing, a second spacing and a third spacing; wherein, the third linewidth is greater than the first linewidth, and the third spacing is greater than the first spacing and the second spacing.

10. The touch panel as recited in claim 3 further satisfying:
G1≦P−W;
wherein, G1 is the first distance; P represents a pitch of the conductive elements in a region between the reference line and the edge of the substrate; and W is the linewidth of the connecting wires.

11. The touch panel as recited in claim 1, wherein the first distance is greater than or equal to 35 μm.

12. The touch panel as recited in claim 1, wherein the decoration layer is a single-layer structure, and a composition of the single-layer structure comprises light shading material.

13. The touch panel as recited in claim 1, wherein the decoration layer is a multi-layer structure.

14. The touch panel as recited in claim 13, wherein the multi-layer structure includes at least two layer structures having different colors contrasting to each other.

15. The touch panel as recited in claim 1, wherein the conductive elements are made of a same material or a plurality of materials selected from a transparent conductive material, a nano metal film or a carbon nanotube, and a metal mesh structure including metal with a linewidth less than 5 μm.

16. The touch panel as recited in claim 1 further comprising a plurality of separated insulating patterns disposed between the conductive elements and the decoration layer, so that the decoration layer and an interval between the at least two cross-interface portions outward of the reference line are separated.

17. The touch panel as recited in claim 1, wherein a portion of the conductive elements further constructs a plurality of auxiliary electrodes, the auxiliary electrodes are disposed at a region inward of the reference line, each auxiliary electrode is at least disposed between two adjacent conductive elements in the touch sensing units, and is separated from the two adjacent conductive elements with the second distance.

18. The touch panel as recited in claim 1, wherein the touch sensing units comprise a plurality of first electrodes and a plurality of second electrodes, wherein each first electrode comprises a plurality of first branches directing toward the second electrode adjacent thereof, and the second electrodes comprise a plurality of second branches directing toward the first electrodes adjacent thereof, and the first branches and the second branches are arranged in a staggered manner.

19. The touch panel as recited in claim 1, wherein the outer margin of the decoration layer and the edge of the substrate are spaced from a distance, and the touch panel further comprises a light shielding layer at least covering a portion of a region where the decoration layer locates and extendedly covering at least a portion of a sidewall of the substrate.

20. The touch panel as recited in claim 1 further comprising a insulating layer, the insulating layer being selected from an anti-reflective optical film, a planarization layer and a combination thereof; wherein, the anti-reflective optical film covers the conductive elements or is disposed between the substrate and the conductive elements, and the anti-reflective optical film comprises at least two laminated layers having different refractivity; wherein, the planarization layer covers the conductive elements and has a thickness of at least 0.8 μm.

21. The touch panel as recited in claim 1 further comprising an overlay covering the substrate and the decoration layer, wherein a difference between a refractivity of the overlay and a refractivity of the substrate is less than 0.3, and the conductive elements are directly disposed on the overlay.

22. A touch panel comprising:
a substrate;
a decoration layer disposed on at least one side of the substrate, the decoration layer having a multi-layer structure, and an outermost layer structure in the multi-layer structure away from the substrate having an outer margin and a inner margin, the outer margin being closer to an edge of the substrate than the inner margin, wherein the inner margin is located between the outer margin and a reference line, and the reference line is at least 20 μm apart from the inner margin; and
a plurality of conductive elements disposed on the substrate, the conductive elements comprising at least two cross-interface portions, the at least two cross-interface portions cover the decoration layer and a region on the substrate without the decoration layer;
wherein, a distance between the at least two cross-interface portions adjacent to each other comprises a first distance in a region outward of the reference line to the outer margin, and comprises a second distance in a region inward of the reference line, and the first distance is greater than the second distance;
wherein, the conductive elements at least construct a plurality of touch sensing units, and each touch sensing unit is used to form a capacitance coupling.

23. The touch panel as recited in claim 22, wherein the multi-layer structure of the decoration layer comprises a non-black decoration layer disposed between the substrate and the outermost layer structure, and the outermost layer structure comprises light shading material.

24. The touch panel as recited in claim 22, wherein the first distance is greater than or equal to 35 μm.

25. The touch panel as recited in claim 22 further comprising a plurality of separated insulating patterns disposed between the conductive elements and the decoration layer, so that the decoration layer and an interval between the at least two cross-interface portions outward of the reference line are separated.

26. The touch panel as recited in claim 22, wherein a portion of the conductive elements further construct a plurality of auxiliary electrodes, the auxiliary electrodes are disposed at a region inward of the reference line, each auxiliary electrode is at least disposed between the two adjacent conductive elements in the touch sensing units, and is separated from the two adjacent conductive elements with the second distance.

27. The touch panel as recited in claim 22, wherein the at least two cross-interface portions construct at least a portion of the touch sensing units.

28. The touch panel as recited in claim 22, wherein the conductive elements further construct a plurality of connecting wires electrically connected to at least a portion of the touch sensing units, and at least a portion of the connecting wires covering the decoration layer and the region on the substrate without the decoration layer so as to be at least a part of the cross-interface portions.

29. The touch panel as recited in claim 22, wherein an edge of the decoration layer keeps a distance apart from the edge of the substrate, and the touch panel further comprises a light shielding layer at least covering a portion of a region where the decoration layer locates and extendedly covering at least a portion of a sidewall of the substrate.

30. The touch panel as recited in claim 22 further comprising a insulating layer, the insulating layer being selected from an anti-reflective optical film, a planarization layer and a combination thereof; wherein, the anti-reflective optical film covers the conductive elements or is disposed between the substrate and the conductive elements, and the anti-reflective optical film comprises at least two laminated layers having different refractivity; wherein, the planarization layer covers the conductive elements and has a thickness of at least 0.8 μm.

31. The touch panel as recited in claim 22 further comprising an overlay covering the substrate and the decoration layer, wherein a difference between a refractivity of the overlay and a refractivity of the substrate is less than 0.3, and the conductive elements are directly disposed on the overlay.

32. A touch panel comprising:
a substrate;
a light resistant layer disposed on the substrate to form a budge structure, the light resistant layer comprising at least one layer structure; and
a plurality of conductive elements disposed on the substrate, the conductive elements comprising at least two cross-interface portions, the at least two cross-interface portions covering the light resistant layer and a region on the substrate without the light resistant layer;
wherein, the light resistant layer comprises a contacting surface contacted with the at least two cross-interface portions;
wherein, in a coverage of the contacting surface, a distance between the at least two cross-interface portions adjacent to each other is greater than or equal to 35 μm; and
wherein, the conductive elements at least construct a plurality of touch sensing units, and each touch sensing unit is used to form a capacitance coupling.

33. The touch panel as recited in claim 32, wherein the light resistant layer has a multi-layer structure, an outermost layer structure of the light resistant layer comprises a light shading material, an interaction between the outermost layer structure and the at least two cross-interface portions is greater than an interaction between the rest of the multi-layer structure and the at least two cross-interface portions.

34. The touch panel as recited in claim 33, wherein the multi-layer structure of the light resistant layer comprises a non-black decoration layer disposed between the substrate and the outermost layer structure.

35. The touch panel as recited in claim 32 further comprising a plurality of separated insulating patterns disposed between the conductive elements and the light resistant layer, so as to separate an interval between at least two cross-interface portions from the light resistant layer.

36. The touch panel as recited in claim 32, wherein a portion of the conductive elements further construct a plurality of auxiliary electrodes being not in contact with the light resistant layer, each auxiliary electrode is at least disposed between the two adjacent conductive elements, and is separated from the two adjacent conductive elements with a distance less than 30 μm.

37. The touch panel as recited in claim 32, wherein the at least two cross-interface portions construct at least a portion of the touch sensing units.

38. The touch panel as recited in claim 32, wherein the conductive elements further construct a plurality of connecting wires electrically connected to at least a portion of the touch sensing units, and at least a portion of the connecting wires covering the decoration layer and the region on the substrate without the decoration layer so as to be at least a part of the cross-interface portions.

39. The touch panel as recited in claim 38, wherein the at least a portion of the connecting wires comprises a bent portion, and each bent portion is disposed at the region on the substrate without the decoration layer, so that, in the connecting wires, a minimum distance between the outermost two connecting wires on the light resistant layer is greater than a minimum distance between the outermost two connecting wires in the region on the substrate without the light resistant layer.

40. The touch panel as recited in claim 39, wherein N amount of the touch sensing units construct a same serial group, a minimum width of the connecting wires is M μm, a farthest distance from the at least one bent portion to the inner margin of the decoration layer is at least N multiplied by M μm.

41. The touch panel as recited in claim 39, wherein a shielding wire is disposed between the at least a portion of the connecting wires and the touch sensing units, the shielding wire is connected to a reference potential, and a width of the shielding wire is at least 50 μm.

42. The touch panel as recited in claim 39, wherein each of the at least a portion of the connecting wires comprises at least two different linewidths and at least two different spacings each between adjacent two of the at least a portion of the connecting wires.

43. The touch panel as recited in claim 42, wherein each of the at least a portion of the connecting wires, from a starting end connecting to the corresponding touch sensing unit to a terminal end, comprises a first linewidth, a second linewidth, and a third linewidth; and the spacings between adjacent two of the at least a portion of the connecting wires, from the starting end to the terminal end, comprises a first spacing, a second spacing and a third spacing; wherein, the third linewidth is greater than the first linewidth, and the third spacing is greater than the first spacing and the second spacing.

44. The touch panel as recited in claim 32, wherein the touch sensing units comprise a plurality of first electrodes and a plurality of second electrodes, wherein each first electrode comprises a plurality of first branches directing toward the second electrode adjacent thereof, and the second electrodes comprise a plurality of second branches directing toward the first electrodes adjacent thereof, and the first branches and the second branches are arranged in a staggered in manner.

45. The touch panel as recited in claim 32 further comprising a insulating layer, the insulating layer being selected from an anti-reflective optical film, a planarization layer and a combination thereof; wherein, the anti-reflective optical film covers the conductive elements or is disposed between the substrate and the conductive elements, the anti-reflective optical film comprises at least two laminated layers having different refractivity; wherein, the planarization layer covers the conductive elements and has a thickness of at least 0.8 μm.

46. The touch panel as recited in claim 32, wherein an interaction between the contacting surface and the at least two cross-interface portions is greater than an interaction between the substrate and the at least two cross-interface portions.
